(19) United States
(12) Patent Application Publication
(10) Pub. No.: US 2013/0304635 A1
(43) Pub. Date: Nov. 14, 2013

(54) MOBILE TERMINAL AND CONTROLLING METHOD THEREOF

(71) Applicants: Myeonghwan Cho, Seoul (KR); Jaejoon Park, Seoul (KR)

(72) Inventors: Myeonghwan Cho, Seoul (KR); Jaejoon Park, Seoul (KR)

(21) Appl. No.: 13/892,528

(22) Filed: May 13, 2013

(30) Foreign Application Priority Data
May 14, 2012 (KR) 10-2012-0050794

(51) Int. Cl. G06Q 20/32

(52) U.S. Cl. CPC G06Q 20/3278
USPC 705/39; 705/35

(57) ABSTRACT

A mobile terminal and controlling method thereof are disclosed. The present invention supportive of NFC (near field communication) technology includes a controller configured to control an offer of at least one 1^{st} service except a payment service among a plurality of services to be suspended until a 1^{st} time if a preset event occurs, wherein the NFC technology is applied to a plurality of the services. Accordingly, if a preset event occurs, the present invention suspends a reader service function for prescribed duration, thereby preventing a delay or failure in providing a payment service function.

Pursuant to 35 U.S.C. §119(a), this application claims the benefit of earlier filing date and right of priority to Korean Application No. 10-2012-0050794, filed on May 14, 2012, the contents of which are hereby incorporated by reference herein in their entirety.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for facilitating a terminal to be used in further consideration of user's convenience.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

As an NFC (near field communication) function is loaded on a mobile terminal, both a reader function and a payment service function for making payments can be simultaneously supported by the mobile terminal.

If the mobile terminal simultaneously supports both a reader service function and a card payment service function, a reader service request may be generated as soon as a card payment service request is made.

In doing so, since the card payment service request and the reader service request may collide with each other, it may cause a problem that the processing for a card payment service may be delayed or completed unsuccessfully. To solve such a problem, a demand for a corresponding solution is rising.

### SUMMARY OF THE INVENTION

Accordingly, embodiments of the present invention are directed to a mobile terminal and controlling method thereof that substantially obviate one or more problems due to limitations and disadvantages of the related art.

An object of the present invention is to provide a mobile terminal and controlling method thereof, by which NFC (near field communication) is supported to suspend a reader service function in case of occurrence of a preset event.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a mobile terminal supportive of NFC (near field communication) technology according to the present invention may include a controller configured to control an offer of at least one 1^{st} service except a payment service among a plurality of services to be suspended until a 1^{st} time if a preset event occurs, wherein the NFC technology is applied to a plurality of the services.

Preferably, the payment service may include a card payment service and the 1^{st} service may include a reader service.

Preferably, the 1^{st} time may include either a time on which activation of the payment service is completed or a time corresponding to expiration of a preset term.

Preferably, the mobile terminal may further include a user input unit. If the payment service is requested via the user input unit, the controller controls the offer of the 1^{st} service to be suspended until the 1^{st} time.

More preferably, the mobile terminal may further include a sensing unit and the 1^{st} service may include a reader service. If an object to which the reader service will be applied is detected nearby the mobile terminal via the sensing unit, the controller may control the offer of the 1^{st} service to be suspended until the 1^{st} time.

Preferably, the mobile terminal may further include a user input unit. If an application related to the payment service is activated via the user input unit, the controller may control the offer of the 1^{st} service to be suspended until the 1^{st} time.

More preferably, the application related to the payment service may include an application for making payments and an application for an on-line money transfer.

Preferably, the mobile terminal may further include a hot key. If the hot key is selected, the controller may control the offer of the 1^{st} service to be suspended while the hot key is selected.

Preferably, the mobile terminal may further include a user input unit and the mobile terminal is in a locked screen state. If the locked screen state is cancelled via the user input unit, the controller may control the offer of the 1^{st} service to be suspended until the 1^{st} time.

Preferably, the controller may divide a 1^{st} time unit into a 2^{nd} time unit and a 3^{rd} time unit, the controller may control the payment service to be provided in the 2^{nd} time unit, the controller may control the 1^{st} service to be provided in the 3^{rd} time unit, and the 1^{st} time unit may be periodically repeated.

More preferably, the 2^{nd} time unit may be longer than the 3^{rd} time unit.

Preferably, the mobile terminal may further include a memory and the controller may control activation information of the payment service to be saved in the memory.

In another aspect of the present invention, a method of controlling a mobile terminal supportive of NFC (near field communication) technology according to the present invention may include the step of controlling an offer of at least one 1^{st} service except a payment service among a plurality of services to be suspended until a 1^{st} time if a preset event occurs, wherein the NFC technology is applied to a plurality of the services.

Preferably, the payment service may include a card payment service, the 1^{st} service may include a reader service, and the 1^{st} time may include either a time on which activation of the payment service is completed or a time corresponding to expiration of a preset term.

Preferably, if the payment service is requested via the user input unit, the offer of the 1^{st} service may be controlled to be suspended until the 1^{st} time.

More preferably, the 1^{st} service may include a reader service. If an object to which the reader service will be applied is detected nearby the mobile terminal, the offer of the 1^{st} service may be controlled to be suspended until the 1^{st} time.

Preferably, if an application related to the payment service is activated via the user input unit, the offer of the 1^{st} service may be controlled to be suspended until the 1^{st} time. And, the application related to the payment service may include an application for making payments and an application for an on-line money transfer.

Preferably, the mobile terminal may be in a locked screen state. If the locked screen state is cancelled, the offer of the 1^{st} service may be controlled to be suspended until the 1^{st} time.

Preferably, the method may further include the steps of dividing a 1^{st} time unit into a 2^{nd} time unit and a 3^{rd} time unit, providing the payment service in the 2^{nd} time unit, and providing the 1^{st} service in the 3^{rd} time unit. And, the 1^{st} time unit may be periodically repeated.

More preferably, the 2^{nd} time unit may be longer than the 3^{rd} time unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a block diagram of a mobile terminal according to one embodiment of the present invention;

FIG. 2 (a) is a front perspective diagram of a mobile terminal according to one embodiment of the present invention;

FIG. 2 (b) is a rear perspective diagram of a mobile terminal according to one embodiment of the present invention;

FIG. 3 is a diagram to describe a service associated with NFC (near field communication) applicable to the present invention;

FIG. 4 is a diagram for one example of collision between a reader service function and a payment service function in conjunction with the present invention;

FIG. 5A and FIG. 5B are diagrams for one example of suspending a reader service function if a payment service function is activated or a reader service field is detected;

FIG. 6 is a diagram for one example of suspending a reader service function, if a payment service related application is activated, according to one embodiment of the present invention;

FIG. 7 is a diagram for one example of suspending a reader service function using a hot key according to one embodiment of the present invention;

FIG. 8 is a diagram for one example of suspending a reader service function using cancellation of a screen lock according to one embodiment of the present invention; and

FIG. 9 is a diagram to describe one example of discriminating a reader service function provided time and a payment service function provided time using a unit time and repeating the unit time by prescribed periods.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of terminals. Examples of such terminals include mobile terminals, such as mobile phones, user equipment, smart phones, mobile computers, digital broadcast terminals, personal digital assistants, portable multimedia players (PMP) and navigators.

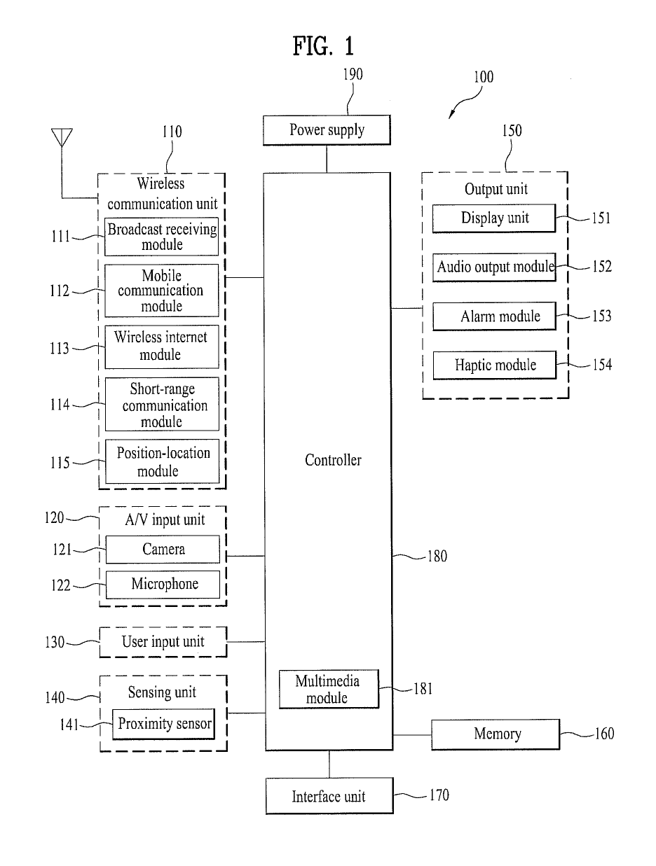

FIG. 1 is a block diagram of a mobile terminal 100 in accordance with an embodiment of the present invention. FIG. 1 shows the mobile terminal 100 according to one embodiment of the present invention includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel.

The broadcast channel may include a satellite channel and a terrestrial channel.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

At least two broadcast receiving modules 111 can be provided to the mobile terminal 100 in pursuit of simultaneous receptions of at least two broadcast channels or broadcast channel switching facilitation.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), DVB-CBMS, OMA-BCAST, the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.) via a mobile network such as GSM (Global System for Mobile communications), CDMA (Code Division Multiple Access), WCDMA (Wideband CDMA) and so on. Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

According to the current technology, the GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc.

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100, and free-falling of the mobile terminal 100. As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, a haptic module 154, a projector module 155 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and a sensor for detecting a touch action (hereinafter called ‘touch sensor’) configures a mutual layer structure (hereinafter called ‘touchscreen’), it is able to use the display 151 as an input device as well as an output device. In this case, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

Referring to FIG. 1, a proximity sensor (141) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The projector module 155 is the element for performing an image projector function using the mobile terminal 100. And, the projector module 155 is able to display an image, which is identical to or partially different at least from the image displayed on the display unit 151, on an external screen or wall according to a control signal of the controller 180.

In particular, the projector module 155 can include a light source (not shown in the drawing) generating light (e.g., laser) for projecting an image externally, an image producing means (not shown in the drawing) for producing an image to output externally using the light generated from the light source, and a lens (not shown in the drawing) for enlarging to output the image externally in a predetermined focus distance. And, the projector module 155 can further include a device (not shown in the drawing) for adjusting an image projected direction by mechanically moving the lens or the whole module.

The projector module 155 can be classified into a CRT (cathode ray tube) module, an LCD (liquid crystal display) module, a DLP (digital light processing) module or the like according to a device type of a display means. In particular, the DLP module is operated by the mechanism of enabling the light generated from the light source to reflect on a DMD (digital micro-mirror device) chip and can be advantageous for the downsizing of the projector module 151.

Preferably, the projector module 155 can be provided in a length direction of a lateral, front or backside direction of the mobile terminal 100. And, it is understood that the projector module 155 can be provided to any portion of the mobile terminal 100 according to the necessity thereof.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern (or image) recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

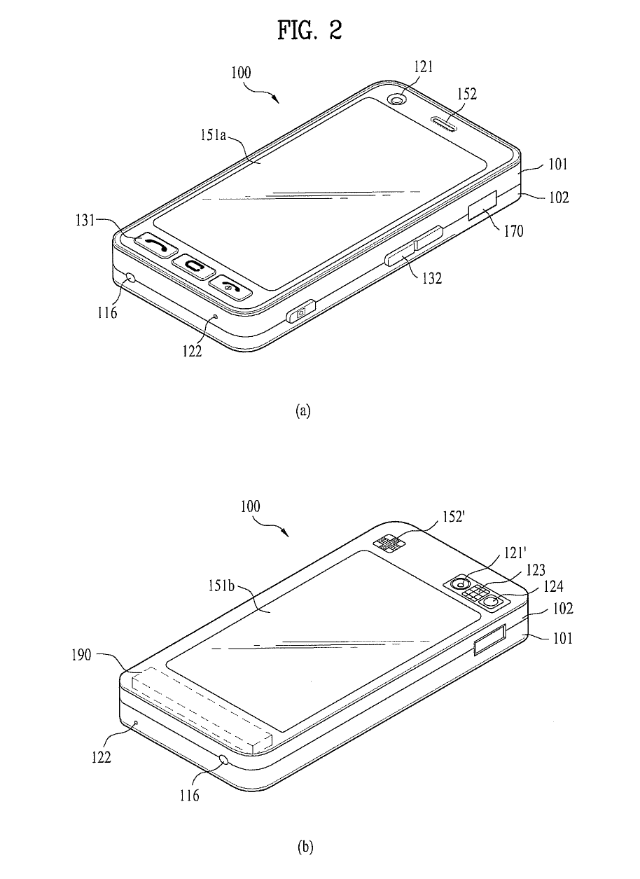

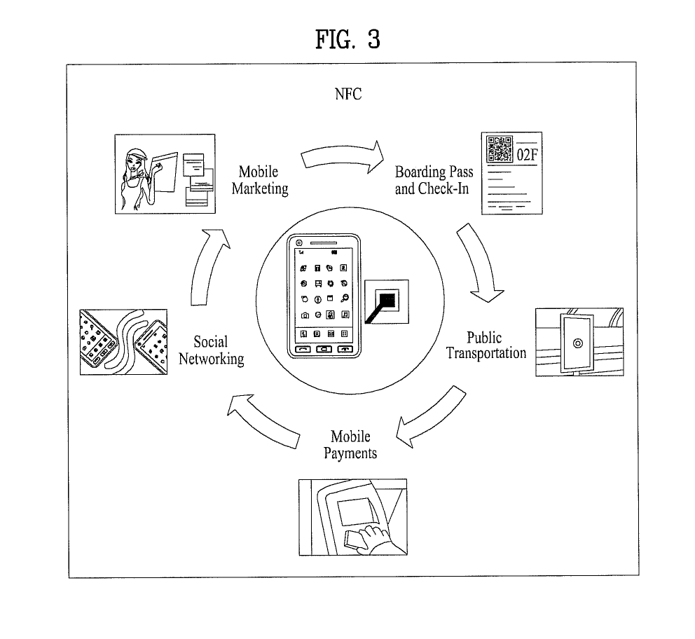

FIG. 2 (a) is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 2 (a), the mobile terminal 100 includes a case (casing, housing, cover, etc.) configuring an exterior thereof. In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

The cases 101 and 102 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the terminal body, and more particularly, to the front case 101.

The display 151 occupies most of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display 151 or the like can be inputted to the second manipulating unit 132.

FIG. 2 (b) is a perspective diagram of a backside of the terminal shown in FIG. 2 (a).

Referring to FIG. 2 (b), a camera 121′ can be additionally provided to a backside of the terminal body, and more particularly, to the rear case 102. The camera 121 has a photographing direction that is substantially opposite to that of the former camera 121 shown in FIG. 2 (a) and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a minor 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2 (a) and may be used for implementation of a speakerphone mode in talking over the terminal.

A broadcast signal receiving antenna 124 can be additionally provided to the lateral side of the terminal body as well as an antenna for communication or the like. The antenna 124 constructing a portion of the broadcast receiving module 111 shown in FIG. 1 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad 135 for detecting a touch can be additionally provided to the rear case 102. The touchpad 135 can be configured in a light transmittive type like the display 151. In this case, if the display 151 is configured to output visual information from its both faces, it is able to recognize the visual information via the touchpad 135 as well. The information outputted from both of the faces can be entirely controlled by the touchpad 135. Alternatively, a display is further provided to the touchpad 135 so that a touchscreen can be provided to the rear case 102 as well.

The touchpad 135 is activated by interconnecting with the display 151 of the front case 101. The touchpad 135 can be provided in rear of the display 151 in parallel. The touchpad 135 can have a size equal to or smaller than that of the display 151.

In the following description, embodiments related to a controlling method implemented in the above-configured mobile terminal shall be explained with reference to the accompanying drawings.

First of all, NFC (near field communication) is a sort of an electronic tag (e.g., RFID) and means the technology of transmitting data between terminals in a near distance via a non-contact short range wireless communication module using a specific frequency band (e.g., 13.56 MHz, etc.).

The NFC (near field communication) is widely applicable to transmission of goods information of supermarket or general shop, transmission of travel information for visitors, traffics, entry control locking device and the like as well as to payment.

Such an NFC technology may be applicable to the mobile terminal 100.

In case of applying the NFC technology, if a terminal having a built-in tag in concept extending from the conventional RFID is operated in active mode, a function of a reader for reading a tag and a function of a writer for inputting information to a tag can be performed as well as a unique function of a tag. Moreover, the NFC technology enables terminal-to-terminal P2P.

ISO 18092 (International Standard of NFC) is compatible with ITSO 14443 (International Standard of non-contact type smart card), Felica by Sony, MiFare by Philips and the like.

For instance, NFC tag may be categorized into 4 kinds of types shown in Table 1.

TABLE 1

| Classification | Type 1 | Type 2 | Type 3 | Type 4 |
|---|---|---|---|---|
| RF interface | ISO 14443A | ISO 1443A | ISO 18092 | ISO 14443 |
| Speed | 106 kbps | | 212 kbps | 106~424 kbps |
| Protocol | Self- | Self- | Felica | ISO 14443~4 |
| | command | command | protocol | ISO 7816~4 |
| Memory size | 1 KB or | 2 KB or | 1 MB or | 64 KB or |
| | smaller | smaller | smaller | smaller |

| | | |
|---|---|---|
| Applied | Low-capacity tag for single | High-capacity tag for multi- |
| fields | application service | application service |

Yet, the NFC tag types shown in Table 1 are just exemplary. And, it is apparent that other NFC tag types are available for implementation of NFC tag.

Moreover, NFC may be sorted in the 3 kinds of operating modes shown in Table 2. Yet, Table 2 just shows one example of the present invention. And, it is apparent that NFC is available in other operating modes.

TABLE 2

| MODE | Description |
|---|---|
| Device-to-device | Since direct communications (e.g., data transmission |
| communication | between smart phones, file sharing between PC and |
| (PSP) | smart phone, information update between smart |
| | phones, etc.) between all devices supportive of NFC |
| | can be processed through a single contact and are |
| | implemented by a physical and intuitive user using |
| | scheme called ‘contact’, the data communication |
| | can be connected very conveniently. |
| Reader/Tag (R/W) | Direct information acquisition is achieved by |
| | contacting NFC smart phone with an RFID tag |
| | attached poster and a new service connection is |
| | available by providing a connection to a related |
| | website. |
| Card emulation | This mode can provide a safe mobile payment |
| (SC) | method c by combining a non-contact type smart |
| | card technology and a security technology together |
| | and can be utilized as various payment means |
| | including a public transportation card, a discount |
| | coupon and the like. If PC provides NFC, the NFC |
| | can be very conveniently usable as authentication |
| | and payment means of E-commerce. |

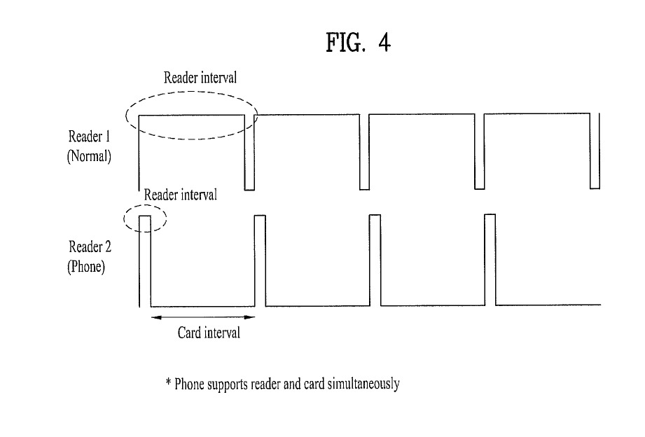

Moreover, representative application services of the NFC applied to the mobile terminal 100 can be sorted as shown in FIG. 3. Yet, the detailed application services described with reference to FIG. 3 are simple examples to which the present invention is applicable. And, it is apparent that other application services are available.

First of all, the NFC is applicable to a terminal-to-terminal contact application service between mobile terminals.

For instance, the contact application service may include one of a payment service for making payments, a money transfer service via on-line account linkage, a business card information (e.g., contact, email, etc.) exchange service, a wireless communication access service such as a paring for terminal-to-terminal data exchange, and the like.

Secondly, the NFC is applicable to a personal information management application service.

For instance, the personal information management application service may include one of a door opening/closing service through authentication, a personal authentication service for electronic product (e.g., laptop, etc.) user authentication and the like, an access control service for a remote control of a building, a vehicle and the like.

Thirdly, the NFC is applicable to an information offer & customized advertisement related application service.

For instance, the information offer & customized advertisement related application service may include one of a guide service for museum/sightseeing information offer (speech/text) & location guidance and the like, a medical service for a medical record management and the like, a car parking service for a parked location check and the like, a reservation service for a concert ticketing through poster contact, a public transportation ticketing and the like, an advertisement & coupon service for a location based advertisement & coupon offer and the like, a product information service for a product information reading, an authentic product decision, a history tracking, a manual offer, an A/S information offer and the like, a contents purchase service for downloading such a content as an e-book, a song and the like, a social network service for directly transmitting an information read from a tag to a social network, and the like.

Meanwhile, as the NFC (near field communication) is loaded on the mobile terminal 100, both a reader function and a payment service function for making payments can be simultaneously supported by the mobile terminal 100.

For clarity of the following description, assume that the payment service provided by the mobile terminal 100 includes a card payment service.

In case that the mobile terminal simultaneously supports both of the reader service function and the card payment service, a card payment service request and a reader service request may be simultaneously made.

If so, the card payment service request and the reader service request may collide with each other. As such a collision occurs, it may cause a problem that the processing for the card payment service may be delayed or a problem that the processing for the card payment service may be unsuccessfully performed.

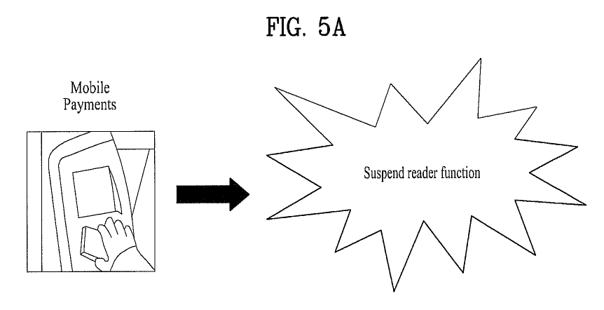

This is described with reference to FIG. 4 as follows.

FIG. 4 is a diagram for one example of collision between a reader service function and a payment service function in conjunction with the present invention, in which a reader service provided interval and a card payment service provided interval of the mobile terminal 100 is displayed using a time axis (X-axis).

Referring to FIG. 4, as the NFC (near field communication) function is loaded on the mobile terminal 100, a user can be provided with a card function and a conventional reader function. In this case, an interval of collision with a previously established read is generated.

In particular, if the reader function and the card function are activated in the mobile terminal 100, it may cause a problem that a processing for a card payment service may be delayed or completed unsuccessfully.

Therefore, in order to solve the problem that the processing for the card payment service may be delayed or completed unsuccessfully, if a preset event occurs, the present invention provides a method of suspending a reader service function for prescribed duration.

Yet, for clarity of the description, the function suspended through the preset event is assumed as the reader service function, by which the present invention is non-limited. And, it is apparent that services other than the payment service may correspond to the function suspended through the preset event.

The preset event may be set up in the course of manufacturing the mobile terminal 100 or may be arbitrarily set up by a user's manipulation.

In the following description, the event for suspending the reader service function for prescribed duration shall be explained in detail.

First of all, when a user makes a request for a card payment service, it may be able to suspend the reader service function unconditionally. In doing so, the time, during which a reader service function is suspended, may mean the time taken to complete the processing for the card payment service or the time taken until a preset time expires.

Secondly, when a user makes a request for a card payment service, the sensing unit 140 detects whether another reader field exists nearby the mobile terminal 100 under the control of the controller 180. Only if at least one different reader field is detected, it is able to suspend a reader service function.

In particular, when the request for the card payment service is received, only if the different reader field actually exists nearby the mobile terminal 100, the reader service function may be suspended.

Moreover, in case that a user activates an application for making a request for a card payment service, it is able to suspend a reader service function.

In particular, since the activation of the application for making the request for the card payment service means the activation of the card payment service, it is able to facilitate the activation of the card payment service by suspending the reader service function. In doing so, the time, during which the reader service function is suspended, may mean the time taken to complete the processing for the card payment service or the time taken until a preset time expires.

Moreover, in case that a user selects a hot key separately provided to the mobile terminal 100, it may be able to suspend a reader service function.

In doing so, the time, during which a reader service function is suspended, may mean the time taken to complete the processing for the card payment service or the time taken until a preset time expires.

Moreover, it may be able to apply a method of suspending a reader service function only if a user is pressing the hot key.

Moreover, if a user turns on LCD or cancels a screen lock, it may be able to suspend a reader service function.

In doing so, the time, during which a reader service function is suspended, may mean the time taken to complete the processing for the card payment service or the time taken until a preset time expires.

Yet, the detailed events mentioned in the above description correspond to simple examples to which the present invention is applicable. And, other events, by which a card payment service is interrupted, can be further included.

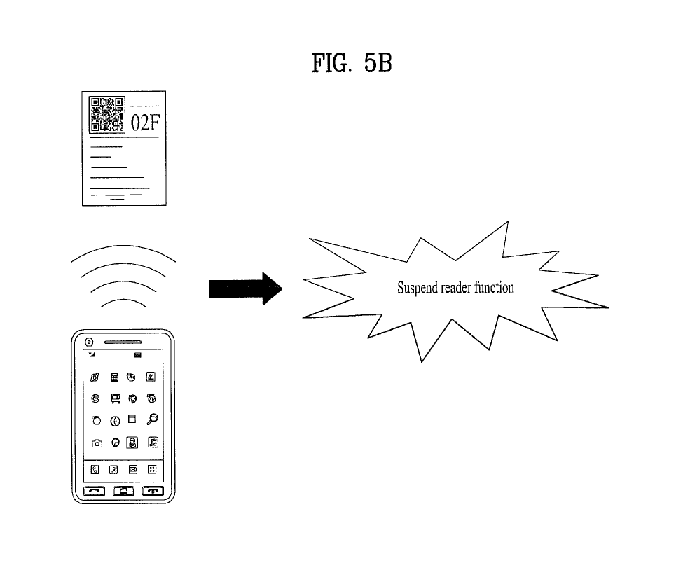

In the following description, an embodiment for a detailed event, to which the present invention is applicable, is explained with reference to FIGS. 5A to 8.

FIG. 5A shows one example of suspending a reader service function unconditionally if a request for a card payment service is made by a user.

Referring to FIG. 5A, if a processing for a requested card payment service is completed or a preset time expires, a reader service function is suspended. Hence, the card payment service can be quickly processed without being delayed or completed unsuccessfully.

FIG. 5B shows one example as follows. First of all, when a user makes a request for a card payment service, the sensing unit 140 detects whether another reader field exists nearby the mobile terminal 100 under the control of the controller 180. Only if at least one different reader field is detected, it is able to suspend a reader service function.

In particular, when the request for the card payment service is received, only if the different reader field actually exists nearby the mobile terminal 100, the reader service function may be suspended.

Hence, the card payment service can be quickly processed without being delayed or completed unsuccessfully.

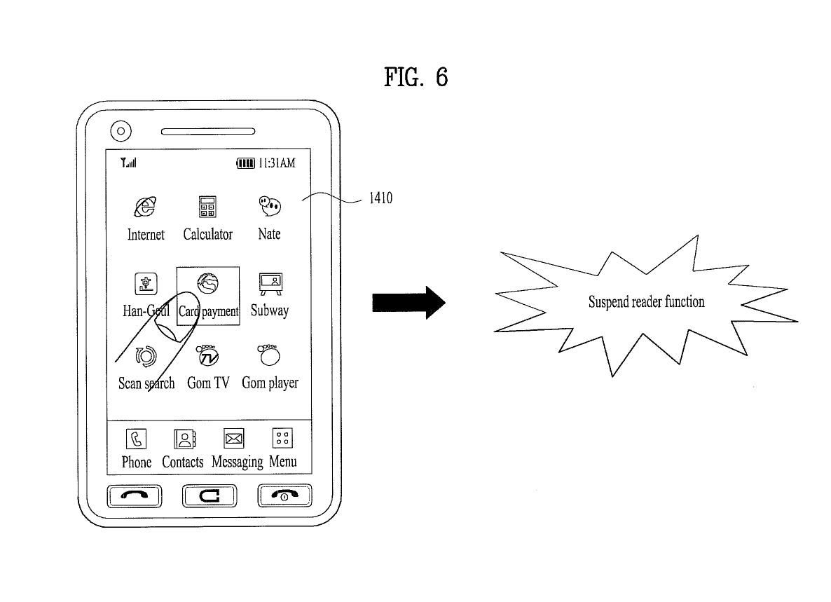

FIG. 6 is a diagram for one example of suspending a reader service function, if a payment service related application is activated by a user, according to one embodiment of the present invention.

Referring to FIG. 6, applications applicable to this example may include a payment application for making payments, a money transfer application for transactions via on-line account linkage, and the like.

Therefore, since the activation of the application for making the request for the card payment service means the activation of the card payment service, it is able to facilitate the activation of the card payment service by suspending the reader service function.

In doing so, the time, during which the reader service function is suspended, may mean the time taken to complete the processing for the card payment service or the time taken until a preset time expires.

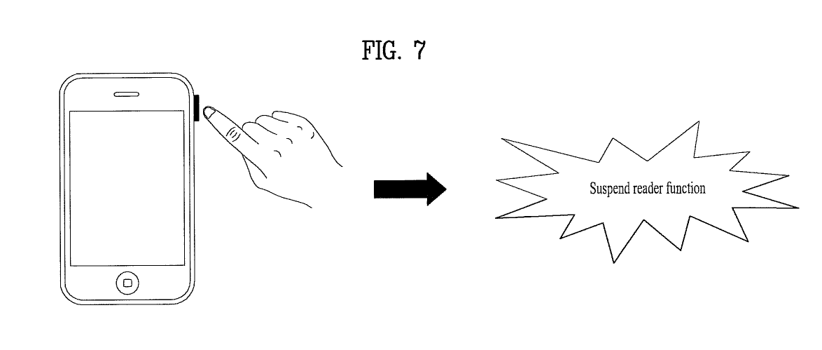

FIG. 7 is a diagram for one example of suspending a reader service function, if a user selects a hot key separately provided to the mobile terminal 100, according to one embodiment of the present invention.

Yet, if a user selects a separate menu or inputs a touch of a preset pattern or the like, it may be able to suspend the reader service function.

In doing so, the time, during which the reader service function is suspended, may mean the time taken to complete the processing for the card payment service or the time taken until a preset time expires.

Moreover, it may be able to apply a method of suspending a reader service function only if a user is pressing the hot key.

In particular, the reader service function is suspended only while the user is pressing the hot key. If the selection of the hot key is cancelled, the reader service function may be re-activated.

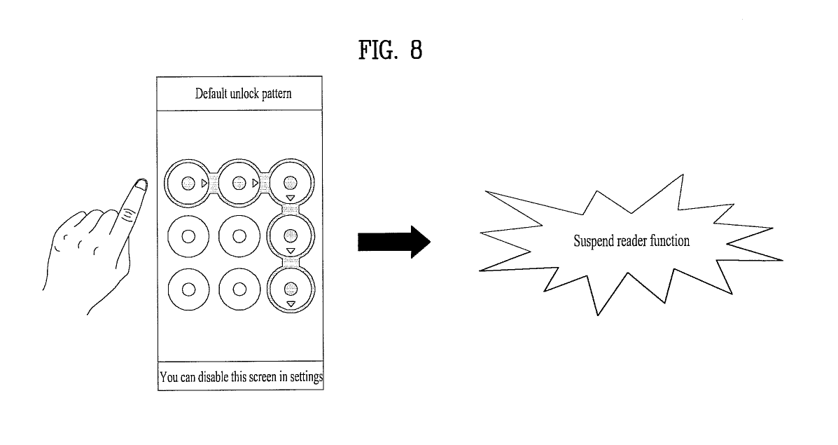

FIG. 8 is a diagram for one example of suspending a reader service function using cancellation of a screen lock according to one embodiment of the present invention.

Referring to FIG. 8, since it is highly possible that an event in which a user cancels a screen lock or an idle mode state directly results in an event of activating a card payment service, the above-mentioned method is used.

In doing so, the time, during which a reader service function is suspended, may mean the time taken to complete the processing for the card payment service or the time taken until a preset time expires.

Therefore, the card payment service can be quickly processed without being delayed or completed unsuccessfully.

Meanwhile, according to one embodiment of the present invention, a unit interval is divided into a reader service provided interval and a card payment service provided interval. If the unit interval is repeated by periods, it is able to prevent the delay or failure in providing a card payment service.

In particular, the mobile terminal 100 provides a card payment service only in the card payment service provided interval, while providing a reader service only in the reader service provided interval. Therefore, the card payment service can be securely provided.

In doing so, comparing the card payment service and the reader service with each other, the reader service consumes battery power more than that of the card payment service and the card payment service may be used more frequently than the reader service. Hence, it is preferable that the card payment service provided interval is greater than the reader service provided interval in the unit interval.

For example, assume that the unit interval amounts to 900 ms. In this case, the reader service provided interval may be set to 90 ms of the unit interval and the card payment service provided interval may be set to the rest (i.e., 810 ms).

For another example, assume that the unit interval amounts to 300 ms. In this case, the reader service provided interval may be set to 90 ms of the unit interval and the card payment service provided interval may be set to the rest (i.e., 210 ms).

Moreover, the determined unit interval can keep being repeated using a prescribed cycle.

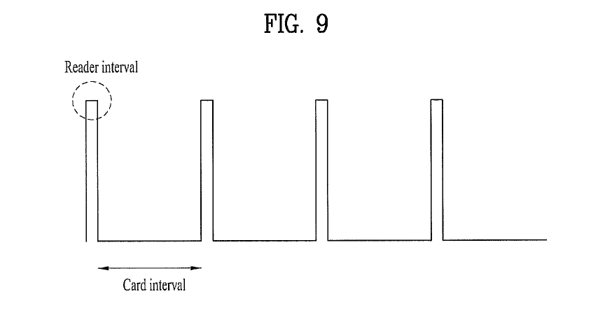

FIG. 9 shows the above-described embodiment of the present invention on time axis (X-axis).

Referring to FIG. 9, the card payment service provided interval is set greater than the reader service provided interval in the unit interval.

Moreover, since one unit interval keeps being repeated by periods, the card payment service and the reader service of the mobile terminal 100 can be provided to a user without collision in-between.

According to another embodiment of the present invention, in case that a card payment service or a reader service is provided to a user, the controller 180 may control information on a corresponding result to be saved in the memory 160.

Therefore, the user is able to check a history of his payments or a reader service provided history with ease using the result information saved in the memory 160.

Accordingly, the present invention provides the following effect and/or feature.

According to at least one of embodiments of the present invention, if a preset event occurs, the present invention suspends a reader service function for prescribed duration, thereby preventing a delay or failure in providing a payment service function.

Effects and/or features obtainable from the present invention may be non-limited by the above mentioned effect. And, other unmentioned effects can be clearly understood from the following description by those having ordinary skill in the technical field to which the present invention pertains.

It will be appreciated by those skilled in the art that the present invention can be specified into other form(s) without departing from the spirit or scope of the inventions.

In addition, the above-described methods can be implemented in a program recorded medium as computer-readable codes. The computer-readable media may include all kinds of recording devices in which data readable by a computer system are stored. The computer-readable media may include ROM, RAM, CD-ROM, magnetic tapes, floppy discs, optical data storage devices, and the like for example and also include carrier-wave type implementations (e.g., transmission via Internet). Further, the computer may include the controller 180 of the terminal.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal, which supports NFC (Near Field Communication) technology, comprising a controller configured to:
execute a plurality of services to which the NFC technology is applied; and
control the execution of at least one service except a payment service among the plurality of services to be suspended until a first time if a predetermined event occurs.

2. The mobile terminal of claim 1, wherein the payment service includes a card payment service and wherein the at least one service includes a reader service.

3. The mobile terminal of claim 1, wherein the first time includes at least one of a time on which activation of the payment service is completed and a time corresponding to expiration of a predetermined interval.

4. The mobile terminal of claim 1, further comprising a user input unit,
wherein the predetermined event includes receiving an user input for requesting the payment service via the user input unit.

5. The mobile terminal of claim 4, further comprising a sensing unit, wherein the at least one service includes a reader service and wherein the predetermined event includes a detection of an object to which the reader service will be applied nearby the mobile terminal via the sensing unit.

6. The mobile terminal of claim 1, further comprising a user input unit, wherein the predetermined event includes receiving a user input for executing an application related to the payment service via the user input unit.

7. The mobile terminal of claim 6, wherein the application related to the payment service includes an application for making payments and an application for an on-line money transfer.

8. The mobile terminal of claim 1, further comprising a hot key, wherein the predetermined event includes receiving an user input via the hot key and wherein the controller further configured to control the execution of at least one service to be suspended while the user input via the hot key is maintained.

9. The mobile terminal of claim 1, further comprising a user input unit and display unit, wherein the predetermined event includes receiving a user input for unlocking the display unit via the user input unit.

10. The mobile terminal of claim 1, wherein the controller further configured to control the payment service to be executed in a first time interval and the at least one service to be executed in a second time interval,
wherein the first time interval and second time interval are periodically and alternately repeated.

11. The mobile terminal of claim 10, wherein the first time interval is longer than the second time interval.

12. The mobile terminal of claim 1, further comprising a memory, wherein the controller is further configured to store activation information of the payment service in the memory.

13. A method of controlling a mobile terminal, which supports NFC (Near Field Communication) technology, comprising:
executing a plurality of services to which the NFC technology is applied; and
controlling the execution of at least one service except a payment service among the plurality of services to be suspended until a first time if a predetermined event occurs.

14. The method of claim 13, wherein the payment service comprises a card payment service, wherein the at least one service includes a reader service, and wherein the first time includes at least one of a time on which activation of the payment service is completed and a time corresponding to expiration of a predetermined interval.

15. The method of claim 13, wherein the predetermined event includes receiving an user input for requesting the payment service via a user input unit.

16. The method of claim 15, wherein the at least one service includes a reader service and wherein the predetermined event includes a detection of an object to which the reader service will be applied nearby the mobile terminal.

17. The method of claim 13, wherein the predetermined event includes receiving an user input for executing an application related to the payment service via the user input unit and wherein the application comprises an application for making payments and an application for an on-line money transfer.

18. The method of claim 13, wherein the predetermined event includes receiving a user input for unlocking a display unit.

19. The method of claim 13, further comprising the steps of:
executing the payment service in a first time interval; and
executing the at least one service in a second time interval,
wherein the first time interval and the second time interval are periodically and alternately repeated.

20. The method of claim 19, wherein the first time interval is longer than the second time interval.
